(19) United States
(12) Patent Application Publication
(10) Pub. No.: US 2013/0194494 A1
(43) Pub. Date: Aug. 1, 2013

(54) APPARATUS FOR PROCESSING IMAGE SIGNAL AND METHOD THEREOF

(71) Applicants: Byung-Ki Chun, Yongin-city (KR); Yong-Seok Choi, Yongin-city (KR); Jong-Woong Park, Yongin-city (KR); Joo-Hyung Lee, Yongin-city (KR)

(72) Inventors: Byung-Ki Chun, Yongin-city (KR); Yong-Seok Choi, Yongin-city (KR); Jong-Woong Park, Yongin-city (KR); Joo-Hyung Lee, Yongin-city (KR)

(21) Appl. No.: 13/470,212

(22) Filed: May 11, 2012

(30) Foreign Application Priority Data
Jan. 30, 2012 (KR) 10-2012-0009194

(51) Int. Cl. H04N 7/01

(52) U.S. Cl. 348/453; 348/E07.003

(57) ABSTRACT

A video signal processing apparatus and a video signal processing method are provided. The video signal processing apparatus includes an image processing apparatus configured to receive and convert an external input image data signal into an output image data signal according to a color arrangement structure, wherein the image processing apparatus includes at least one current limiter to remap the external input image data signal with expanded number of bits.

### CROSS-REFERENCE TO RELATED APPLICATION

This application claims priority to and the benefit of Korean Patent Application No. 10-2012-0009194 filed in the Korean Intellectual Property Office on Jan. 30, 2012, the entire contents of which are incorporated herein by reference.

### BACKGROUND

(a) Field

The present invention relates to an apparatus for processing a video signal and a method thereof.

(b) Description of the Related Art

Recently, various flat panel displays with reduced weight and volume have been developed.

The flat panel displays include a liquid crystal display (LCD), a field emission display (FED), a plasma display panel (PDP), and an organic light emitting diode (OLED) display.

Among the flat panel displays, the organic light emitting diode display is a flat display device using an electro-luminescence phenomenon of an organic material. An organic light emitting diode emits light using a mechanism in which electrons and holes are injected from electrodes, and the injected electrons and holes are combined in an excitation state.

The organic light emitting diode display can have reduced volume and weight because an additional light source is not required, and it may be used for an electronic product such as a portable terminal or a large-sized television with advantages of low power consumption, high luminous efficiency, high luminance, and wide viewing angle, as well as a fast response speed.

The organic light emitting diode (OLED) display displays images by using organic light emitting elements as self-light emitting elements. The organic light emitting element emits light according to a current depending on an image data signal, and a current consumption is increased to display bright light of a high gray level such that it is desirable to use less amount of power for various display applications.

Accordingly, a driving technique for lowering power consumption of the organic light emitting diode (OLED) display has been recently developed, and application of an image data rendering algorithm to realize images on a screen with low power driving and research to solve a quantization error of expression of gray levels are desired.

The above information disclosed in this Background section is only for enhancement of understanding of the background of the invention, and therefore it may contain information that does not form the prior art that is already known in this country to a person of ordinary skill in the art.

### SUMMARY

Embodiments of the present invention are directed to a video signal processing apparatus and a method thereof for applying a low power driving technique that is capable of being applied to a color data rendering algorithm and reducing a quantization error in the expression of gray levels in the processing of an image data signal.

Embodiments of the present invention are directed to a video signal processing apparatus without an additional wire or increasing the size of a driving IC of an image display device. That is, a clear screen may be provided and low power consumption may be realized by correctly performing an expression of gray levels while using the image display device.

Also, embodiments of the present invention are directed to compatibility of applying a lower power driving technique to a color data rendering algorithm in the video signal processing apparatus.

A video signal processing apparatus according to an exemplary embodiment of the present invention includes an image processing apparatus configured to receive and convert an external input image data signal to an output image data signal according to a color arrangement structure. The image processing apparatus includes a first device and a second device for processing the external input image data signal with expanded number of bits, and at least one current limiter between the first device and the second device, and configured to remap the external input image data signal with the expanded number of bits.

The current limiter may be configured to calculate a compensating data signal for color data by using a compensating luminance value that is converted according to the expanded number of bits, such that a quantization error of gray level information in the compensating data signal is reduced.

The image processing apparatus may include a gray level adjustor for adjusting a data signal according to the expanded number of bits for a color adjustment of the input image data signal, a data preprocessor for preparing a sharpening filter value used for data rendering according to the color arrangement structure, a data rendering apparatus for rendering the data signal adjusted according to the expanded number of bits according to the color arrangement structure, an edge processor for processing a color data signal concentrated to an edge portion of a display panel, and a dithering apparatus for receiving the color data signal processed by the edge processor and converting the received color data signal according to a reduced number of bits corresponding to a number of bits of a data signal displayed in the display panel and compensating a color error due to a difference of the number of bits to output the output image data signal.

The image processing apparatus may further include a gamma data generator for converting and outputting the data signal that is rendering-processed. At this time, the number of bits of the rendering-processed data signal may be reduced.

According to an exemplary embodiment of the present invention, the image processing apparatus may further include a current limiter connected between the gray level adjustor and the data preprocessor.

A current limiter connected between the edge processor and the dithering apparatus may be further included.

The edge processor may be configured to process a green color data signal concentrated to the edge portion of the display panel.

The color arrangement structure may be a pentile structure. The current limiter may include a power save readability enhancement (PSRE) processor for adjusting a gray level data value so as to have different slopes in a curve of a luminance ratio in relation to a gray level, wherein a first gray level region of the curve includes gray levels lower than a reference gray level, a second gray level region of the curve includes gray levels higher than the reference gray level, and the first gray level region and the second gray level region have different slopes.

The PSRE processor may be configured to adjust a gray level data value for the slope of the first gray level region to be lower than the slope of the second gray level region.

A video signal processing method according to an exemplary embodiment of the present invention for receiving an image data signal, converting according to a color arrangement structure, and generating and outputting an output image data signal for a display to a display panel, the method includes performing a data adjustment by remapping of the input image data signal to automatically limit a driving current amount during the process of converting the image data signal, by expanding a number of bits of data.

The performing the data adjustment may include compensating color data by using a compensating luminance value that is converted according to the expanded number of bits, while reducing a quantization error in gray level information of the compensated color data.

The video signal processing method may further includes a color adjusting step of converting the input image data signal into a data signal according to the expanded number of bits for color adjustment of the input image data signal, a preprocessing step of preparing a sharpening filter value for data rendering according to a color arrangement structure, a rendering step of rendering the data signal that is adjusted according to the expanded number of bits according to the color arrangement structure, an edge processing step of processing a color data signal concentrated to an edge portion of the display panel, and a dithering step of receiving and converting the edge processed color data signal to a reduced number of bits according to the number of bits of the data signal displayed in the display panel, and compensating for a color error due to a difference of the number of bits to output the output image data signal.

As an exemplary embodiment, after the rendering step, a step of converting and outputting the rendering processed data signal may be further included. At this time, the number of bits of the output data signal may be reduced as compared with the expanded number of bits of the rendering processed data signal.

The video signal processing method may further include a data adjusting step of automatically limiting the driving current amount between the color adjusting step and the preprocessing step.

The video signal processing method may further include a data adjusting step of automatically limiting the driving current amount between the edge processing step and the dithering step.

According to embodiments of the present invention, in the processing process of the image data signal, the low power driving technique may be applied to the color data rendering algorithm, and concurrently (e.g., simultaneously) the quantization error of the expression of gray levels that may be generated in the low power driving technique may be reduced.

A video signal may be simply processed without an additional wire or increasing the size of a driving IC in an image display device. That is, a clear screen may be provided and low power consumption may be realized by correctly performing expression of gray levels while using the image display device.

Also, compatibility of the low power driving technique applied to the color data rendering algorithm may be obtained when using the image processing apparatus and the method thereof of the embodiments of the present invention.

### BRIEF DESCRIPTION OF THE DRAWINGS

FIG. 1 is a block diagram of a display device including an image processing apparatus (e.g., an image processing unit) according to an exemplary embodiment of the present invention.

FIG. 2 is a graph comparing gray level-luminance relationships according to a conventional image processing method and an image processing method according to an exemplary embodiment of the present invention.

FIG. 3 is a block diagram showing a configuration according to an exemplary embodiment of an image processing unit shown in FIG. 1.

FIG. 4 is a block diagram of a portion of the configuration of the image processing unit shown in FIG. 3.

FIG. 5 is a block diagram of a configuration of another exemplary embodiment of the image processing unit shown in FIG. 1.

FIG. 6 is a block diagram of a portion of the configuration of the image processing unit shown in FIG. 5.

FIG. 7 is a graph comparing gray level-luminance relationships according to a conventional image processing method and an image processing method according to an exemplary embodiment of the present invention.

FIG. 8 is a block diagram of a portion of a configuration according to another exemplary embodiment of the image processing unit shown in FIG. 3.

FIG. 9 is a block diagram of a portion of a configuration according to another exemplary embodiment of the image processing unit shown in FIG. 8.

### DETAILED DESCRIPTION OF THE EMBODIMENTS

Hereinafter, the present invention will be described more fully with reference to the accompanying drawings, in which exemplary embodiments of the invention are shown. As those skilled in the art would realize, the described exemplary embodiments may be modified in various different ways, all without departing from the spirit or scope of the present invention.

Further, like reference numerals denote like components throughout several exemplary embodiments. A first exemplary embodiment will be representatively described, and thereafter only components other than those of the first exemplary embodiment will be described in detail in other exemplary embodiments.

The drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through one or more third elements. In addition, unless explicitly described to the contrary, the word “comprise” and variations such as “comprises” or “comprising” will be understood to imply the inclusion of stated elements but not the exclusion of any other elements.

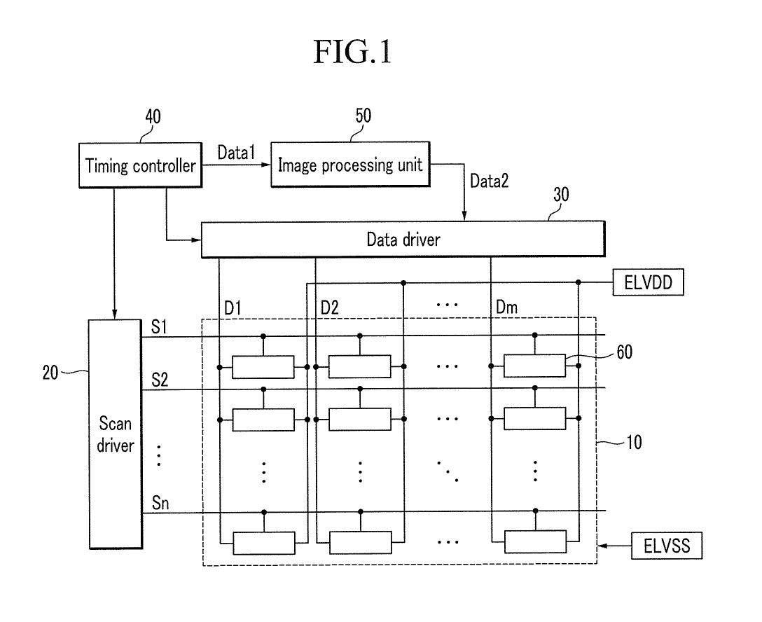

FIG. 1 is a block diagram of a display device including an image processing apparatus according to an exemplary embodiment of the present invention.

A display device including an image processing apparatus according to an exemplary embodiment of FIG. 1 includes a display unit 10 including a plurality of pixels 60 connected to a plurality of scan lines S1 to Sn and a plurality of data lines D1 to Dm. The plurality of pixels 60 may respectively include a subpixel displaying a color of red, green, or blue.

The display device includes a scan driver 20 for transmitting a corresponding scan signal to the plurality of pixels 60 through the plurality of scan lines S1 to Sn.

Also, the display device includes a data driver 30 for transmitting a corresponding data signal to the plurality of pixels 60 through the plurality of data lines D1 to Dm. When the pixel 60 includes a plurality of subpixels for displaying RGB colors, the data signal may include a data signal for each color of RGB.

Also, the display device includes a timing controller 40 to control the scan driver 20 and the data driver 30, and an image processing unit 50 for receiving a plurality of first image data signals Data1 as an external input image data from the timing controller 40. The image processing unit 50 converts the first image data signals Data 1 into a plurality of second image data signals Data2 and transmits them to the data driver 30.

The timing controller 40 generates a data driving control signal and a scan driving control signal corresponding to synchronization signals supplied from the outside. The data driving control signal generated by the timing controller 40 is supplied to the data driver 30, and the scan driving control signal is supplied to the scan driver 20.

Also, the timing controller 40 provides the first image data signals Data1, supplied from the outside to the image processing unit 50.

The scan driver 20 receives the scan driving control signal from the timing controller 40 to generate a plurality of scan signals. The plurality of generated scan signals are sequentially supplied to the plurality of scan lines S1 to Sn.

The data driver 30 receives the data driving control signal from the timing controller 40 and a plurality of the processed second image data signals Data2 from the image processing unit 50. Also, the, data driver 30 respectively supplies a plurality of the second image data signals Data2 to the plurality of data lines D1 to Dm in synchronization with the scan signals.

The display unit 10 receives the first power source voltage ELVDD and the second power source voltage ELVSS from the outside and applies them to each of the pixels 60.

The first power source voltage ELVDD is applied to each of the pixels 60 by a first power source, and the second power source voltage ELVSS is applied to each of the pixels 60 by a second power source.

The pixels 60 respectively emit light corresponding to the second image data signals Data2 by controlling the driving current which flows from the first power source to the second power source through the light emitting element of each pixel. That is, each of the pixels 60 generates light of a set or predetermined luminance corresponding to the second image data signals Data 2.

The image processing unit 50 receives the first image data signals Data1 as the external input image data and performs color data rendering processing and automatic current limit (ACL) driving processing on the data to convert it into the second image data signals Data2.

In one embodiment, the color data rendering processing remaps the images according to a pentile structure, and the image processing unit 50 according to an exemplary embodiment of the present invention inserts the automatic current limit algorithm into the rendering algorithm and processes it according to the pentile structure. Accordingly, by inserting and processing the ACL algorithm when a number of bits of a gamma data signal for display is expanded in the image remapping process, agglomeration of the expression of gray levels according to a quantization error generated in the conventional ACL technique may be naturally removed or reduced. Also, without addition of the data line to increase the number of bits of the data to reduce the quantization error or a size increase of the driving IC, the automatic current limit driving technique may be performed by using the same device for performing the image remapping process of the data signal included in the image processing unit 50.

The image processing unit 50 changes and processes a mapping equation for each color data signal when the current limit driving algorithm is applied corresponding to the number of bits that is increased in the rendering process for each color of the first image data signal Data1.

Accordingly, the second image data signal Data2 output to the data driver 30 is the gamma data that is converted according to the data rendering, and concurrently (e.g., simultaneously) the gamma data of which the luminance value of each color data is recalculated by the automatic current limit driving.

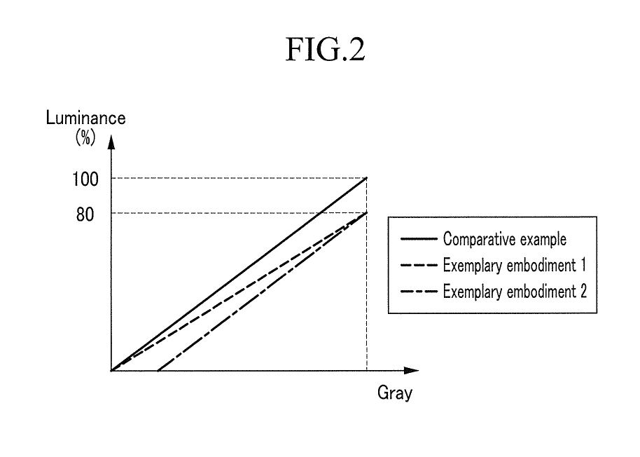

FIG. 2 is a graph comparing gray level-luminance relationships according to a conventional image processing method and image processing methods according to exemplary embodiments of the present invention. Here, the graph of FIG. 2 shows a luminance ratio for the gray level in the image processing process applied with a conventional image processing process and the automatic current limit technique.

The automatic current limit (ACL) technique is a driving method for controlling an amount of current consumed in the display unit, thereby reducing the current consumption and realizing a dynamic contrast. Here, the amount of current driving the light emitting element of the pixel corresponds to the data signal input to the display unit. According to an exemplary embodiment of the present invention, a small amount of luminance information of all data can be converted at a certain degree that a user may not recognize the difference as compared with the original image data input from the outside, thereby reducing the current consumption.

The luminance ratio linearly increases as the gray level is increased according to a general image processing process (Comparative Example) that is not applied with the automatic current limit technique, where a 100% luminance is displayed at the highest gray level.

According to the driving method of an Exemplary Embodiment 1 of FIG. 2, the automatic current limit technique converts the gray level data such that a slope of the luminance-gray level of the Exemplary Embodiment 1 is less than the slope of the luminance-gray level of the Comparative Example. According to an Exemplary Embodiment 2, the automatic current limit technique converts the gray level data such that the curve of the luminance-gray level of the Exemplary Embodiment 2 is moved to be lower than that of the Comparative Example while maintaining the same slope as that of the Comparative Example.

That is, the Exemplary Embodiment 1 controls the luminance information of the image data for the light to be emitted to a degree of about 80% of that of the image of the Comparative Example, by performing the automatic current limit driving. That is different from the image processing of the Comparative Example that generates the luminance of 100% at the highest gray level. In the automatic current limit driving of the Exemplary Embodiment 1, the luminance for the lowest gray level is the same as that of the Comparative Example such that the slope of the Exemplary Embodiment 1 is decreased as compared with that of the Comparative Example, and thereby a luminance difference generated between the gray levels is decreased.

Different from the Exemplary Embodiment 1, the automatic current limit driving method of the Exemplary Embodiment 2 controls the data to display a black image with the luminance of 0% in a black region when the gray level is at less than a set or predetermined gray level. Also, in general, the luminance is controlled to be darker in the gray level region, exclusive of the black region, as compared with that of the general image processing. However, according to the Exemplary Embodiment 2, the difference of the luminance ratio generated between the gray levels in the gray level region besides the black region is similar to that of the Comparative Example. That is, the slopes of the Comparative Example and the Exemplary Embodiment 2 are substantially the same.

As stated above, the method of processing the images by applying the automatic current limit technique converts the data into a different gray level to decrease the luminance as compared with the Comparative Example such that errors may be generated below the decimal point in the quantization process. Therefore, when the image between the gray levels is displayed, an image agglomeration occurs, that is, different gray levels are showed with the same luminance between adjoining gray levels.

When the automatic current limit technique is combined with the algorithm for rendering data according to the pentile structure, the combined image processing driving method is simplified such that the quantization error may be avoided or reduced. Accordingly, in the image processing apparatus and the image processing method according to the present invention, the automatic current limit techniques of the Exemplary Embodiment 1 and Exemplary Embodiment 2 are applied to the data rendering algorithm of the pentile structure, and concurrently (e.g., simultaneously), the quantization error of the automatic current limit technique may be removed or reduced.

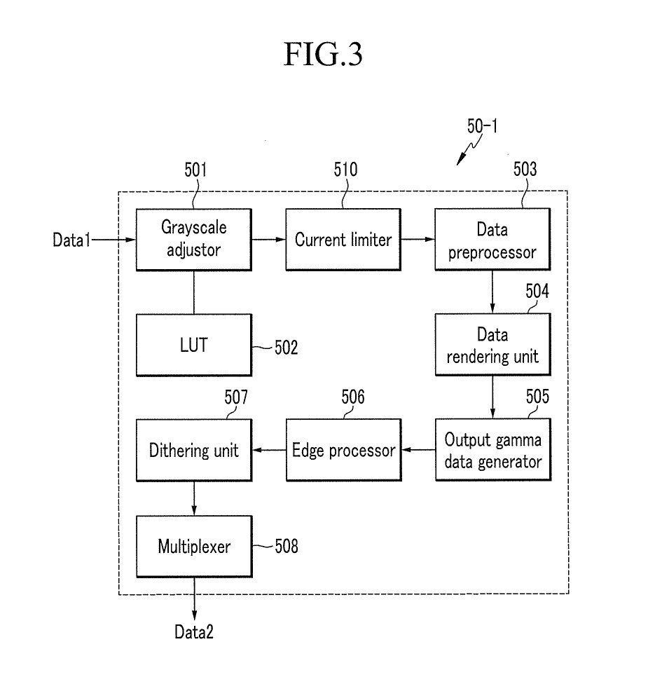

The image processing apparatus shown in FIG. 3 is an embodiment of the image processing unit 50 of the display device of FIG. 1.

Referring to FIG. 3, the image processing unit 50-1 renders and processes the external first image data signal Data1 according to the pentile structure of the color data, and concurrently (e.g., simultaneously) performs a conversion process of the gamma data according to the automatic current limit driving shown in FIG. 2 to output the second image data signal Data 2 to the data driver 30.

The image processing unit 50-1 of FIG. 3 includes a gray level adjustor 501, a look-up table (LUT) 502 of the gamma data, a current limiter 510, a data preprocessor 503, a data rendering unit 504, an output gamma data generator 505, an edge processor 506, a dithering unit 507, and a multiplexer 508.

The gray level adjustor 501 receives the external first image data signal Data1.

In the image processing unit 50-1 according to an exemplary embodiment of the present invention, the current limiter 510, which converts the luminance information of the color data according to the automatic current limit method, is provided between the gray level adjustor 501 and the data preprocessor 503. Also, the data signal with the adjusted gray level is transmitted from the gray level adjustor 501.

The gray level adjustor 501 extracts a gamma data value representing the luminance information of the input first image data signal Data1 to adjust the number of bits representing the gamma data value to increase a gray level slope pattern according to a color mode. The color mode is not limited, and it may be set as a 565 color mode.

The image processing unit 50-1 according to an exemplary embodiment of the present invention performs an algorithm for processing the data according to the pentile structure, and the gray level adjustor 501 functions as an interface for receiving the first image data signal Data 1 from the outside and remapping the image according to the pentile structure.

The gray level adjustor 501 increases the number of bits of the input gamma data for expressing a gray level gamma value (a gray level data) of a color data signal of red R, green G, and blue B colors in connection with the lookup table 502. Here, the RGB color data signals correspond to the subpixels for displaying the RGB colors, respectively.

For example, if the number of bits of the gray level data is 8, the gray level adjustor 501 may expand and change the number of bits to 11 in reference to the lookup table 502.

The lookup table 502 is connected to the gray level adjustor 501 and may be a part of the image processing unit 50-1. In one embodiment, however, the lookup table 502 may alternatively be formed as an additional memory unit.

In one embodiment, the lookup table 502 is a table for storing the gamma value for the luminance information that is displayed by the RGB color data signals, and the number of bits of the data information is expanded. The first image data signal Data 1 input to the gray level adjustor 501 is used as an index of the lookup table 502.

The gray level adjustor 501 converts the gray level data representing the luminance information included in the first image data signal Data 1 into a gray level data of a different number of bits representing the same luminance by using the lookup table 502.

The current limiter 510 receives the image data signal of which the gamma value is converted to have expanded number of bits by the gray level adjustor 501, and again adjusts the gray level data value. The current limiter 510 maintains the number of bits of the gamma value that is expanded by the gray level adjustor 501. The gray level data of all image data signals is readjusted such that the luminance of the highest gray level is decreased from 100% to a set or predetermined luminance (for example 80%).

According to the current limit driving method of the Exemplary Embodiment 1 or Exemplary Embodiment 2 of FIG. 2, the gray level data representing the luminance information may be converted to reduce the luminance.

Here, the gamma value of the data signal transmitted to the current limiter 510 is displayed with the expanded number of bits (e.g., 11) such that a conversion equation of the color data signal in the current limiter 510 is changed to be suitable for the expanded number of bits.

For example, if the following Equation 1 for the red data signal of 8 bits is used in the conventional current limit driving, the red data signal that is expanded to 11 bits is processed according to the following Equation 2.

Ro=Ri−(DY/255)Ri Equation 1

Ro=Ri−(DY/2047)Ri Equation 2

In Equation 1, the red input data Ri input to the current limiter is converted and output as red output data Ro by using a compensating luminance value DY in the current limit driving of the related art. According to Equation 1, the highest luminance is expressed with 8 bits having 256 gray levels.

The current limiter 510 according to an exemplary embodiment of the present invention expands the red input data Ri to 11 bits such that the compensating luminance value DY in the current limit driving is also changed to 11 bits as in Equation 2. The changed compensating luminance value DY may be obtained by expanding the number of bits of the conventional compensating luminance value or based on a suitable 11 bits value from an external setting unit.

The gamma data conversion equation of the color data signal of Equation 2 is a gray level data conversion equation of which the highest luminance is displayed with a 2048 gray level of 11 bits such that the current limiter 510 may be directly coupled and function between the gray level adjustor 501 and the data preprocessor 503 of the image processing unit 50-1.

The green data signal and blue data signal are likewise processed with equations similar to Equation 1 and Equation 2. That is, like the red input data Ri and the red output data Ro of Equation 1 and Equation 2, the green input data Gi or the blue input data Bi, and the green output data Go or the blue output data Bo, may be respectively replaced and processed.

In the current limiter 510, the amount of current for luminance display is compensated for in a power saving mode for all RGB image data signals according to the automatic current limit driving method.

The data preprocessor 503 receives the data signal that has been compensated for in the power saving mode.

The data preprocessor 503 pre-scans the transmitted RGB data signal and prepares a sharpening filter value according to a sharpening filter setting. The filter value is applied in a rendering (SPR) process of the color data of each subpixel. The sharpening filter setting is selected according to the pre-scan result, and the selection method may be programmed through the system register. The RGB color data signal passing through the data preprocessor 503 expresses three colors of R, G, and B with 11 bits.

The data rendering unit 504 processes the RGB color data signal transmitted through the data preprocessor 503, and in one embodiment of the present invention, the data may be rendering-processed according to the pentile structure.

That is, the RGB color data signal may be reconstituted with a different color data signal (hereinafter referred to as pentile data) such as RG1BG2 and RGBW. In one embodiment, a multi-line buffer may be used.

Also, a green adaptive filter may be selectively added according to an exemplary embodiment of the pentile constitution.

Accordingly, the data rendering unit 504 converts the RGB color data signal expressed by 11 bits into the pentile data expressed by 11 bits, and outputs it.

The output gamma data generator 505 converts the pentile data transmitted from the data rendering unit 504 into the pentile color data signal and outputs it.

The output gamma data generator 505 converts the pentile data according to a reverse function of an input gamma curve to generate the pentile color data signal. Here, the number of bits of the pentile color data signal may be reduced.

The edge processor 506 processes image quality deterioration that may be generated by a collection of the same color data at each edge portion of the entire screen that is output according to the pentile data signal. For screen, the green image can be concentrated by the arrangement of the green signal at the edge portion of the screen in the pentile structure, and thereby the edge processor 506 can sense the green edge and may process and handle the green data signal of the edge portion.

Accordingly, the edge processor 506 outputs the pentile color data signal displayed by, for example, 10 bits as the processed data of the green edge phenomenon.

The dithering unit 507 receives the pentile image data signal that has been finished with the edge processing, and performs a spatiotemporal or spatial dithering to expand a color space and to reduce a quantization error. That is, a defect due to a difference of the displayed color space is compensated for.

The image processing unit 50-1 performs work for the color information of the data with the expanded number of bits in the pentile structure algorithm, and the number of bits of the pentile data signal may be reduced to be expressed with the color information that is recognizable on the screen that is actually displayed. Also, a process of minimizing or reducing the generated color error is also performed.

That is, the dithering unit 507 receives the pentile data signal of 10 bits that has been rendered into the pentile structure in the edge processor 506 in the above example, and the dithering unit 507 reduces the data to 8 bits and adjusts the data to reduce or minimize the generated color error.

If the dithering unit 507 is operated, the pentile color data r_o/g1_o/b_o/g2_o of 8 bits [7:0] is output, and the output gamma data is reduced to 8 bits.

The pentile color data of 8 bits output from the dithering unit 507 is transmitted to the data driver 30 as the second image data signal Data2 through the multiplexer 508.

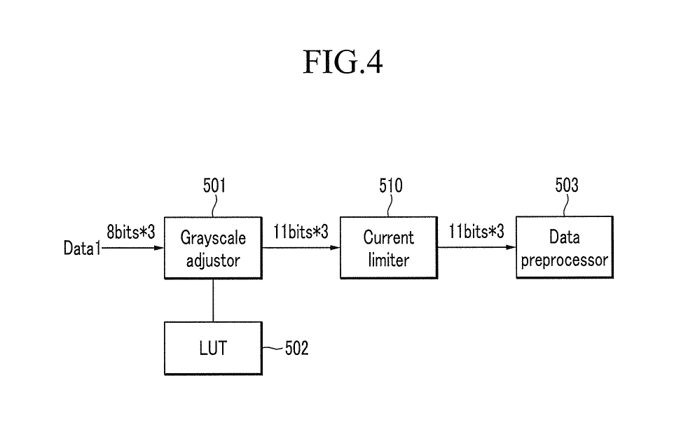

FIG. 4 is a block diagram of a portion of the image processing unit 50-1 shown in FIG. 3.

As illustrated in FIG. 3, the current limiter 510 is located between the gray level adjustor 501 and the data preprocessor 503, and converts the data signal that has been expanded and changed to 11 bits into the data signal that is luminance-compensated according to the current limit driving method.

Referring to FIG. 4, the current limiter 510 utilizes Equation 2 as the data compensating equation such that it may be coupled and process data between the gray level adjustor 501 and the data preprocessor 503. That is, the current limiter 510 that applies the current limit driving technique is inserted between components for performing respective functions of the algorithm according to the pentile structure of the color data in the image processing unit 50-1. Also, the work of processing the color information of the data with the expanded number of bits is utilized in the pentile algorithm such that the quantization error generated in the current limit driving may be reduced.

An example using Equations 1 and 2 will be described as follows.

If the current limit driving technique is applied when processing the image data with 8 bits like in the related art, the gray levels 4 and 5 of the input data signal are both displayed as a gray level of 4 when the compensating luminance value DY is 30 according to Equation 1.

ABS(4×(1−30/255))=4

ABS(5×(1−30/255))=4

However, in the image processing unit 50-1 according to an exemplary embodiment of the present invention, if the current limiter 510 is inserted between the devices or components for processing the data with the pentile structure, the information is processed with the number of bits of the image data converted to 11 bits such that Equation 2 is applied to compensate the data in the current limiter 510.

Thus, in the above example, for the gray level of the input data signal, the gray level of 4 is mapped into a gray level of 32, a gray level of 5 is mapped into a gray level of 40, and the compensating luminance value DY is changed from 30 to 240 according to the expanded number of bits.

If Equation 2 is applied as shown below, the image data for gray levels of 32 and 40 output from the current limiter are respectively expressed with a gray level of 28 and a gray level of 35.

ABS(32×(1−240/2047))=28

ABS(40×(1−240/2047))=35

In the related art, when the image is processed by separately applying the current limit driving technique, a decimal point is omitted such that the gray levels of 4 and 5 are both expressed with a gray level of 4 in the quantization process. However, if the current limiter is inserted between the rendering processing devices of the pentile structure like the image processing unit according an embodiment of the present invention, the current limit driving technique is applied according to the expanded number of bits. Therefore, a gray level of 4 and a gray level of 5 are respectively expressed with a gray level of 28 and a gray level of 35 in a gray level range having 2047 gray levels, and thereby it may be confirmed that the quantization error is reduced or removed.

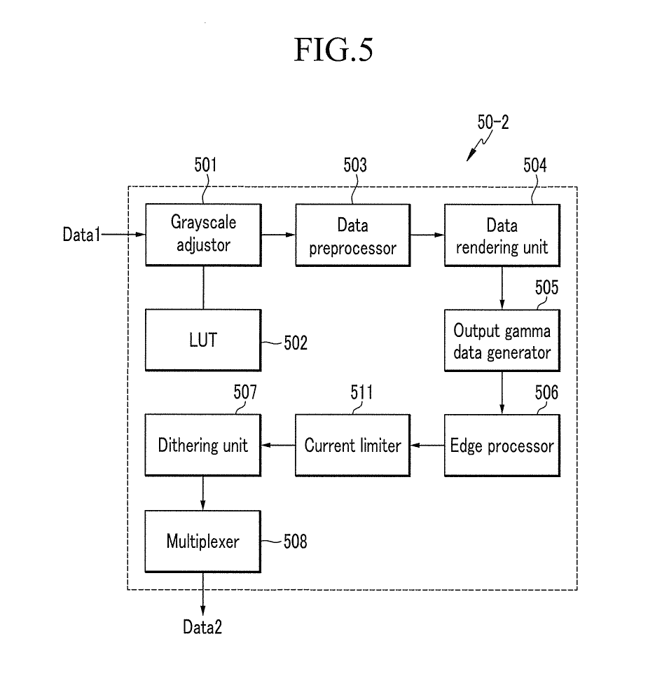

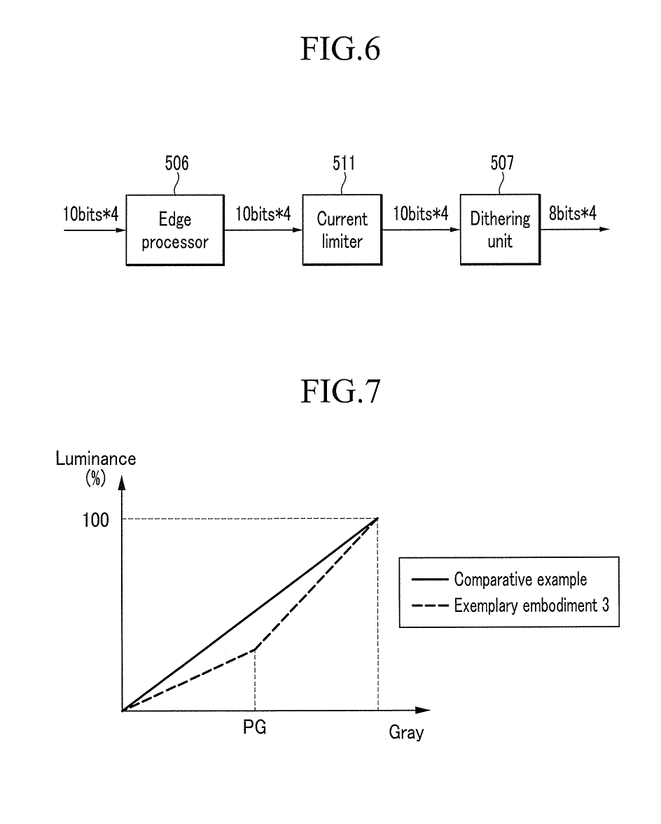

The arrangement of the current limiter is not limited, and an arrangement like in the embodiments of FIG. 5 and FIG. 6 is possible.

FIG. 5 is a block diagram of a configuration of another exemplary embodiment of the image processing unit shown in FIG. 1, and FIG. 6 is a block diagram of a portion of the image processing unit shown in FIG. 5.

The constitution and the function of the image processing unit 50-2 of FIG. 5 are substantially similar to those of FIG. 3 such that the overlapping description is omitted.

Referring to FIG. 5, a current limiter 511 may be disposed between the edge processor 506 and the dithering unit 507.

The pentile image data signal output from the edge processor 506 to the dithering unit 507 is processed with expanded number of bits as compared with the number of bits of the color data displayed in the display unit such that the current limiter 511 may reduce the power consumption of the displayed luminance according to the pentile data signal while reducing the quantization error by using the data signal compensating equation corresponding to the expanded number of bits.

Referring to FIG. 6, the edge processor 506 outputs the gray level data of 10 bits of the pentile structure processed for the green edge. The current limiter 511 receives the gray level data from the edge processor 506 and applies Equation 3 below as the data compensating equation. Equation 3 is an equation for the red data signal, and equations for the green and blue data signals are substantially the same.

Ro=Ri−(DY/1023)Ri Equation 3

The current limiter 511 according to an exemplary embodiment of FIG. 6 expands the red gray level data Ri into 10 bits such that the compensating luminance value DY is also changed into 10 bits. The changed compensating luminance value DY may be obtained by expanding the number of bits of the conventional compensating luminance value or based on a value of 10 bits from an external setting unit.

The gamma data conversion equation of the color data signal of Equation 3 is an expanded gamma data conversion equation of which the highest luminance is expressed with a gray level of 1024 in a gray level of 10 bits such that the current limiter 511 may be directly coupled and function between the edge processor 506 and the dithering unit 507 of the image processing unit 50-2.

FIG. 7 is a graph comparing gray level-luminance relationships according to a conventional image processing method and an image processing method according to an exemplary embodiment of the present invention.

FIG. 7 is a graph showing a luminance ratio expressed by the gray level when applying a power save readability enhancement (PSRE) algorithm, different from the automatic current limit driving technique of FIG. 2.

A comparative example of FIG. 7 shows the luminance ratio for the gray level shown in the image processing of the related art that is not applied with the power save readability enhancement like the comparative example of FIG. 2. In the comparative example, the luminance ratio for the gray level linearly increases as the gray level is increased.

In the PSRE technique, the data signal is adjusted such that the gray level-luminance curve has different regions with different slopes respectively before and after a set or predetermined gray level value PG.

That is, the PSRE technique adjusts the gray level by decreasing the slope like the ACL technique in a gray level region (for example a low gray level region) where the visual recognition of a user may be relatively insensitive to the gamma value of the input data signal in the entire image of the display unit, and by increasing the slope in a gray level region (for example a high gray level region) where the visual recognition of the user may be relatively more sensitive, thereby the PSRE technique can realize high image quality expression without the concentration of the gray levels. In FIG. 7, a graph according to the exemplary embodiment 3 is shown.

In FIG. 7, the region of the gray level lower than the set or predetermined gray level value PG where the visual recognition of the user may be relatively insensitive is a relatively less important portion in the entire image. The data signal corresponding to this region is converted similarly to the ACL technique such that agglomeration of gray levels due to the quantization error may still be generated.

Accordingly, as another exemplary embodiment of the present invention, the PSRE processing device is inserted between the processing devices for the rendering processing algorithm of the pentile structure. Therefore, number of bits of the gray level data is expended when the PSRE processing component processes the color information, thereby reducing the quantization error and realizing the correct expression of gray levels.

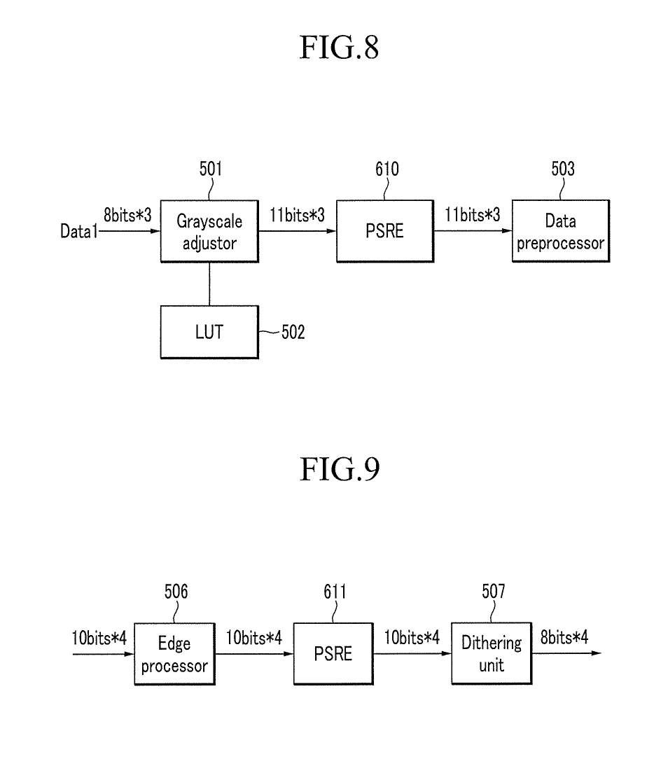

FIG. 8 is a block diagram of a portion of the image processing unit 50-1 shown in FIG. 3 according to another exemplary embodiment, and FIG. 9 is a block diagram of a portion of the image processing unit 50-2 shown in FIG. 5 according to another exemplary embodiment.

In detail, the image processing units according to the exemplary embodiments of FIG. 8 and FIG. 9 each include the PSRE processor according to FIG. 7 instead of the current limiter. That is, the image processing unit according to the exemplary embodiment of FIG. 8 includes a PSRE processor 610 between the gray level adjustor 501 and the data preprocessor 503.

The PSRE processor 610 converts the input gray level data by using a suitable equation for the expanded number of bits between the devices for processing the pentile data signal with the expanded number of bits.

The gray level adjustor 501 in FIG. 8 expands the number of bits of color data signal from 8 bits to 11 bits and outputs the data, and the 11 bits data signal may be transmitted in the relatively unimportant gray level region (e.g., the low gray level region that the user cannot easily distinguish and recognize) and may be changed into the gray level data value according to the current limit technique. The gray level data is expanded to 11 bits and is processed such that the quantization error may be reduced and the agglomeration of gray levels in the low gray level region may be prevented or reduced.

Also, according to the exemplary embodiment of FIG. 9, the image processing unit includes a PSRE processor 611 between the edge processor 506 and the dithering unit 507. This embodiment is similar to FIG. 8 except for the bit number of 10 bits of the pentile data signal. The data is expanded to ten bits as compared with the number of bits of the image data signal generally displayed in the display unit such that the PSRE processor 611 may reduce the quantization error and may prevent or reduce image deterioration.

While exemplary embodiments of the present invention have been particularly shown and described with reference to the accompanying drawings, the specific terms used herein are used for the purpose of describing the invention and are not intended to limit the scope of the invention set forth in the claims. Therefore, those skilled in the art will understand that various modifications and other equivalent embodiments of the present invention are possible. Further, a person of ordinary skill in the art can practice the invention by omitting some of the constituent elements described in the specification without deterioration of performance or adding constituent elements for better performance. In addition, a person of ordinary skill in the art can modify the present invention depending on the process conditions or equipment. Hence, the scope of the present invention is to be determined by the claims and equivalents thereof.

What is claimed is:

1. A video signal processing apparatus comprising:
an image processing apparatus configured to receive and convert an external input image data signal to an output image data signal according to a color arrangement structure,
wherein the image processing apparatus comprises:
a first device and a second device for processing the external input image data signal with expanded number of bits; and
at least one current limiter between the first device and the second device, and configured to remap the external input image data signal with the expanded number of bits.

2. The video signal processing apparatus of claim 1, wherein
the current limiter is configured to calculate a compensating data signal for color data by using a compensating luminance value that is converted according to the expanded number of bits, such that a quantization error of gray level information in the compensating data signal is reduced.

3. The video signal processing apparatus of claim 1, wherein the image processing apparatus comprises:
a gray level adjustor for adjusting a data signal according to the expanded number of bits for a color adjustment of the input image data signal,
a data preprocessor for preparing a sharpening filter value used for data rendering according to the color arrangement structure,
a data rendering apparatus for rendering the data signal adjusted according to the expanded number of bits according to the color arrangement structure,
an edge processor for processing a color data signal concentrated to an edge portion of a display panel, and
a dithering apparatus for receiving the color data signal processed by the edge processor, and converting the received color data signal according to a reduced number of bits corresponding to a number of bits of a data signal displayed in the display panel and compensating a color error due to a difference of the number of bits to output the output image data signal.

4. The video signal processing apparatus of claim 3, wherein
the image processing apparatus comprises a current limiter connected between the gray level adjustor and the data preprocessor.

5. The video signal processing apparatus of claim 3, wherein
the image processing apparatus comprises a current limiter connected between the edge processor and the dithering apparatus.

6. The video signal processing apparatus of claim 3, wherein
the edge processor is configured to process a green color data signal concentrated to the edge portion of the display panel.

7. The video signal processing apparatus of claim 1, wherein
the color arrangement structure is a pentile structure.

8. The video signal processing apparatus of claim 1, wherein the current limiter comprises:
a power save readability enhancement (PSRE) processor for adjusting a gray level data value so as to have different slopes in a curve of a luminance ratio in relation to a gray level,
wherein a first gray level region of the curve comprises gray levels lower than a reference gray level, a second gray level region of the curve comprises gray levels higher than the reference gray level, and the first gray level region and the second gray level region have different slopes.

9. The video signal processing apparatus of claim 8, wherein
the PSRE processor is configured to adjust a gray level data value for the slope of the first gray level region to be lower than the slope of the second gray level region.

10. A video signal processing method for receiving an input image data signal, converting the input image data signal according to a color arrangement structure, and generating and outputting an output image data signal for a display to a display panel, the method comprising:
performing a data adjustment by remapping of the input image data signal to automatically limit a driving current amount during the process of converting the image data signal, by expanding a number of bits of data.

11. The video signal processing method of claim 10, wherein
the performing the data adjustment comprises compensating color data by using a compensating luminance value that is converted according to the expanded number of bits, while reducing a quantization error in gray level information of the compensated color data.

12. The video signal processing method of claim 10, further comprising:
a color adjusting step of converting the input image data signal into a data signal according to the expanded number of bits for color adjustment of the input image data signal;
a preprocessing step of preparing a sharpening filter value for data rendering according to a color arrangement structure;
a rendering step of rendering the data signal that is adjusted according to the expanded number of bits according to the color arrangement structure;
an edge processing step of processing a color data signal concentrated to an edge portion of the display panel; and
a dithering step of receiving and converting the edge processed color data signal to a reduced number of bits according to the number of bits of the data signal displayed in the display panel, and compensating for a color error due to a difference of the numbers of bits to output the output image data signal.

13. The video signal processing method of claim 12, further comprising:
a data adjusting step of automatically limiting the driving current amount between the color adjusting step and the preprocessing step.

14. The video signal processing method of claim 12, further comprising:
a data adjusting step of automatically limiting the driving current amount between the edge processing step and the dithering step.

15. The video signal processing method of claim 12, wherein
a green color data signal concentrated to the edge portion of the display panel is processed in the edge processing step.

16. The video signal processing method of claim 10, wherein
the color arrangement structure is a pentile structure.
